(19) United States
(12) Patent Application Publication
(10) Pub. No.: US 2004/0002319 A1
(43) Pub. Date: Jan. 1, 2004

(54) Harmonic boost technique for direct conversion receiver

(76) Inventor: Ching-Lang Lin, Plano, TX (US)

Correspondence Address: HUGHES & LUCE LLP, 1717 MAIN STREET, SUITE 2800, DALLAS, TX, 75201, US

(21) Appl. No.: 10/353,747

(22) Filed: Jan. 29, 2003

Related U.S. Application Data
(60) Provisional application No. 60/392,723, filed on Jun. 28, 2002.
(60) Provisional application No. 60/392,077, filed on Jun. 28, 2002.
(60) Provisional application No. 60/392,104, filed on Jun. 28, 2002.

(51) Int. Cl. H04B 1/26

(52) U.S. Cl. 455/318; 455/313

(57) ABSTRACT

The present invention describes an Improved Harmonic Boosting Technique (IHBT) for achieving zero DC-offset in a direct conversion receiver (DCR). The technique may be applied to devices such as down converter, combiner, synthesizer, and voltage control oscillator.

The present invention utilizes a voltage control oscillator (VCO) to generate lower even-order frequencies based on the receiver's carrier frequency (RF). A synthesizer, having a digital synthesizing circuit or a frequency multiplier circuit, produces odd order harmonic frequencies from the output of the VCO. A combiner combines odd order harmonic frequencies from the synthesizer to create a local oscillator (LO) signal. A down converter mixes an input signal with the LO output from the combiner.

### CROSS-REFERENCE TO RELATED APPLICATIONS

This application claims the benefit of and incorporates by reference U.S. Provisional Patent Application Serial No. 60/392,723 entitled “Improved Harmonic Boost Technique For Direct Conversion Receiver”, filed on Jun. 28, 2002. Additionally, this application is related to and incorporates by reference U.S. Provisional Patent Application Serial No. 60/392,077, entitled “Harmonic Boost Signals In Up/Down Direct/Super Heterodyne Conversions For Advanced Receiver/Transmitter Architecture”, filed on Jun. 28, 2002, for Ching-Lang Lin. Additionally, this application is related to and incorporates by reference U.S. Provisional Patent Application Serial No. 60/392,104, entitled “Square Wave Local Oscillator Technique for Direct Conversion Receiver”, filed on Jun. 28, 2002, for Ching-Lang Lin.

### FIELD OF THE INVENTION

The present invention relates to the design of direct conversion receiver circuits. More specifically, the invention relates to a direct conversion receiver circuit having zero DC-offset, reduced interference and higher linearity.

### BACKGROUND OF THE INVENTION

With the tremendous growth of wireless communication industry, and migration to higher frequency and bandwidth, the need for better high frequency mixing techniques continues to grow significantly. As a result, sub-harmonic mixing techniques, which historically have been used for millimeter-wave applications, are no longer strangers to mainstream wireless applications such as cell phone and wireless local area network (WLAN) systems. Sub-harmonic passive mixers that exhibit excellent linearity performance are becoming even more attractive for the next generation wireless hardware. However, the difficulty of integrating passive mixers on chip remains a requirement for high LO (local oscillator) power, which leads to significant problems through radiation and substrate coupling and increases the power consumption of the LO buffers.

Currently, most communications and semiconductor companies have concentrated on implementing a direct conversion receiver (DCR) using a system On a Chip (SOC) process. However, designing a DCR using SOC (employing, for example CMOS semiconductor technology) presents severe challenges due to the existence of DC-offset and intra-chip interference. The communication industry has spent more than 50 years attempting to find better solutions to the DC-offset problem. As a result, many solutions exist with varying degrees of complexity and tradeoffs. Traditionally, the LO frequency of a DCR is the same as the receiving RF frequency, consequently the associated DC-offset results in fatal saturation of the baseband amplifiers. Additionally, the associated parasitic capacitance and inductance causes an increase in local oscillator (LO) and synthesizer leakage power which in turn leads to higher intra-chip interference. These drawbacks have become the primary obstacles in the SOC implementation of DCR today. In past years, several remedies have focused only on the second sub-harmonic operations in the converters. However, these solutions still generate a large DC-offset.

### SUMMARY OF THE INVENTION

The present invention describes an Improved Harmonic Boosting Technique (IHBT) for achieving zero DC-offset in a direct conversion receiver (DCR). The technique may be applied to devices such as down converter, combiner, synthesizer, and voltage control oscillator.

The present invention utilizes a voltage control oscillator (VCO) to generate lower even-order frequencies based on the receiver's carrier frequency (RF). A synthesizer, having a digital synthesizing circuit or a frequency multiplier circuit, produces odd order harmonic frequencies from the output of the VCO. A combiner combines odd order harmonic frequencies from the synthesizer to create a local oscillator (LO) signal. A down converter mixes an input signal with the LO output from the combiner.

The present invention provides an Improved Harmonic Boosting Technique (IHBT) that not only produces zero DC offsets but also reduces LO frequency and power. Thus, the present invention provides a solution for achieving SOC for DCR commercialization. The SOC designed using this technique can integrate analog baseband and even down converter circuitry to significantly miniaturize the radio frequency system. Using the system and method of the present invention, the DCR has lower cost, lower intra-chip interference, lower power consumption, and higher linearity. Further, another aspect of the invention allows devices such as converter, combiner, synthesizer and VCO to operate at lower frequencies.

The present invention may achieve these objectives by utilizing circuit devices as discrete components for different chipset applications as follows. One embodiment allows for SOC chipset implementations or a complete DCR application, integrating a VCO, a synthesizer, a combiner and a converter. The VCO circuit generates LOₑ₁ equal to the carrier frequency RF divided by 2n, where n equals one of 1, 2, 3, 4, etc., to provide an input to a digital synthesizer (or frequency multiplier).

The digital synthesizer (or frequency multiplier) circuit, coupled to the VCO circuit, produces n odd harmonic frequencies, LOₑ₁, LOₑ₃ . . . LO_{eoddn} of LOₑ₁. These n odd harmonic frequencies are provided as inputs to a combiner (or adder). Note that output frequency LOₑ₁ equals the input frequency LOₑ₁; for example, LOₑ₃ is the third order harmonic frequency of LOₑ₁ and LO_{eoddn} is the n^{th} odd order harmonic frequency of LOₑ₁. The combiner (or adder) circuit combines these n odd frequencies together to become LOᵣ, the input to the down converter.

The down converter, using an APDP circuit or a modified Gilbert circuit, then mixes a received RF signal with the LOᵣ input to produce a zero intermediate frequency signal (hereafter called zero-IF). The zero-IF signal output can be for I-Channel or Q-Channel.

The improved harmonic boosting technique also may be implemented with separate discrete devices in a DCR system as follows. In all these descriptions, note that LOₑ₁ equals the carrier frequency RF divided by 2n, where n equals one of 1, 2, 3, 4, etc; LOₑ₃ is the third order harmonic frequency of LOₑ₁; LO_{eoddn} is the n^{th} odd order harmonic frequency of LOₑ₁.

In one implementation a VCO may be configured as a discrete device, wherein the VCO circuit generates an output LOₑ₁ frequency which is the carrier frequency RF divided by 2n, where n equals one of 1, 2, 3, 4, etc. Similarly, a down converter may also be configured as a discrete device, wherein the down converter contains an APDP cell, a modified Gilbert cell, or other similar circuit, and a combiner (or adder) circuit. The combiner (or adder) circuit combines n inputs comprising n odd harmonic frequencies of LOₑ₁, which include LOₑ₁, LOₑ₃ . . . LO_{eoddn}, to obtain its output LOᵣ as an input to a down converter circuit. The down converter mixes a received RF signal with LOᵣ from the combiner to produce a zero-IF signal. The zero-IF signal output can be for I-Channel or Q-Channel.

The combiner (or adder) may also be configured as a discrete device. The combiner (or adder) circuit still serves the purpose of combining n inputs, wherein the n inputs comprise n odd harmonic frequencies of LOₑ₁, which include LOₑ₁, LOₑ₃ . . . LO_{eoddn}, to produce its output LOᵣ as the input to a down converter circuit. The digital synthesizer (or frequency multiplier) may also be implemented as a discrete device. The digital synthesizer (or frequency multiplier) circuit still functions to produce outputs comprising n odd harmonic frequencies including LOₑ₁, LOₑ₃ . . . LO_{eoddn} of an input frequency LOₑ₁.

The above components may also be integrated in various combinations to produce additional discrete components. For example, a digital synthesizer (or frequency multiplier) device as described above may be integrated with a combiner as previously described to create a unique discrete component. Alternatively, a device may integrate the functions of a VCO circuit, a digital synthesizer (or frequency multiplier) circuit and a combiner circuit as described in these devices individually described above.

The present invention overcomes the severe challenges imposed by the existence of DC-offset and intra-chip interference, allowing communications and semiconductor companies to implement a direct conversion receiver (DCR) using a system On a Chip (SOC) process. Thus, the present invention allows the design of a DCR using SOC (employing, for example, CMOS semiconductor technology).

The present invention addresses a need that the communication industry has spent more than 50 years attempting to find a better solution. As a result, most prior solutions contain various degrees of complexity and tradeoffs. The present invention lowers the LO frequency of a DCR from the traditional same frequency as the receiving RF frequency. Consequently, the present invention eliminates the fatal saturation of the baseband amplifiers. Additionally, the present invention eliminates associated parasitic capacitance and inductance that caused an increase in local oscillator (LO) and synthesizer leakage power which in turn leads to higher intra-chip interference.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts a schematic diagram of a preferred embodiment of the present invention configured as the IHBT for DCR of SOC chipset implementations or discrete component applications;

FIG. 2 describes a schematic diagram of a VCO device as a discrete component in a DCR according to the IHBT of the present invention;

FIG. 3 presents a schematic diagram of a down converter device as discrete components in a DCR according to the IHBT of the present invention;

FIG. 4 depicts a schematic diagram of a combiner (or an adder) device as a discrete component in a DCR according to the IHBT of the present invention;

FIG. 5 illustrates a schematic diagram of a digital synthesizer (or frequency multiplier) device as a discrete component in a DCR according to the IHBT of the present invention;

FIG. 6 provides a schematic diagram of a digital synthesizer (or frequency multiplier) device as a discrete component in a DCR according to an IHBT implemented in another embodiment of the present invention; and

FIG. 7 provides a schematic diagram of a digital synthesizer (or frequency multiplier) device as discrete components in a DCR according to an IHBT implemented in a further preferred embodiment of the present invention.

### DETAILED DESCRIPTION OF THE INVENTION

Preferred embodiments of the present invention are illustrated in the FIGURES, like numerals being used to refer to like and corresponding parts of the various drawings.

Although the present invention is described in detail, it should be understood that various changes, substitutions and alterations can be made hereto without departing from the spirit and scope of the invention as described by the appended claims.

The present invention revolutionizes the traditional DCR design and offers many advantages, such as zero DC-offset, reduced interference and higher linearity. The present invention provides a significant advantage by eliminating the requirement of big blocking capacitance between the down converter and the baseband amplifier in an otherwise traditional DCR configuration. The present invention also affects the design of down converters, combiners, digital synthesizers (or frequency multipliers), and VCOs as well. This invention has a wide area of application in communication systems including but not limited to wireless, satellite, radar, microwave, radio frequency DCR, and other applications as known to those skilled in the art. The present invention serves as a breakthrough in the design of DCR as well as providing a long-sought solution to the SOC implementation of DCR systems.

The present invention, by using IHBT in DCR design, allows lower LO power, lower conversion loss, enhanced signal strength, reduced noise figure, increased dynamic range and higher received linearity. The lowering of frequencies in the VCO circuit and LO path provide conditions necessary for obtaining zero DC-offset in DCRs. Additionally, the resulting lower intra-chip interference and lower power requirements enable the realization of a DCR SOC chipset. SOC, using this technique, integrates many devices such as Modem, analog baseband, and down converter into one SOC. This integration reduces the size of associated receiver systems, and allows a further cost savings to be achieved.

In the present invention, the LO signal contains a lower even-order harmonic of the carrier frequency RF, and its multiple odd-order harmonic frequencies. Hence, the LO of the present invention has the inherent advantages of operating at lower frequencies and lower power. Therefore, by not using traditional higher frequencies for LO, the present invention eliminates the generating of DC-offsets, as well as coupling issues, and reduces intra-chip interference. The present invention allows the implementation of SOC for DCR to become a reality. Furthermore, the present invention provides a solution to current bottlenecks in the development of an SOC implementation of a DCR. Using these techniques, the DCR has a lower noise figure and overall power consumption. These reductions are particularly useful in wireless devices such as current and future communications systems using standards such as GSM, GPRS, cdma2000, WCDMA, DCS, blue tooth, and others.

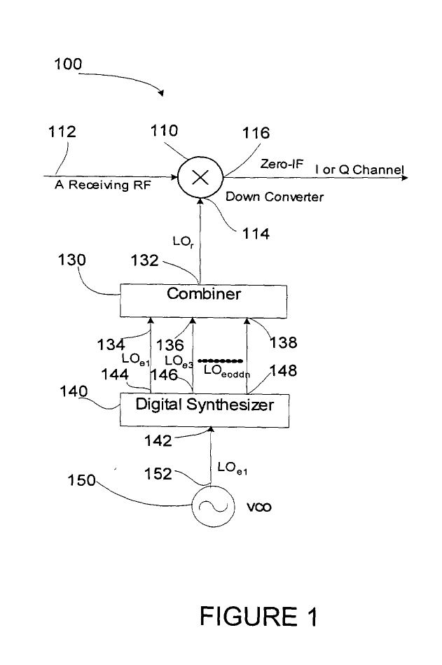

FIG. 1 depicts a block diagram showing the IHBT of the present invention embodied as a SOC chipset or discrete components of DCR 100. Here, a VCO 150 generates output frequency 152. The output port 152 of VCO 150 connects to input port 142 of digital synthesizer (or frequency multiplier) circuit 140. The digital synthesizer (or frequency multiplier) circuit 140 in turn produces n number of output frequencies (LOₑ₁, LOₑ₃ .. . LO_{eoddn}) at ports 144, 146, and 148, respectively. These output ports are connected to the input ports 134, 136 and 138 of combiner (or adder) circuit 130. Combiner (or adder) circuit 130 combines these signals at input ports 134, 136, and 138 to produce output signal (LOᵣ) at output port 132. Output port 132 electrically connects to input port 114 of down converter circuit 110. An APDP cell, a modified Gilbert cell, or other similar circuit known to those skilled in the art, may be used as down converter circuit 110. Down converter circuit 110 functions to mix a received RF signal on port 112 with the combiner output LOᵣ on port 114 to produce a zero-IF signal at port 116. The zero-IF signal is boosted in this DCR using the n number of frequencies, LOₑ₁, LOₑ₃, . . . LO_{eoddn} as described above.

In the FIGURES, LOₑ₁ is defined for consistency as the carrier frequency RF divided by 2n, where n is one of 1, 2, 3, 4, etc. For example, LOₑ₃ is the third order harmonic frequency of LOₑ₁ and LO_{eoddn} is the n^{th} odd order harmonic frequency of LOₑ₁.

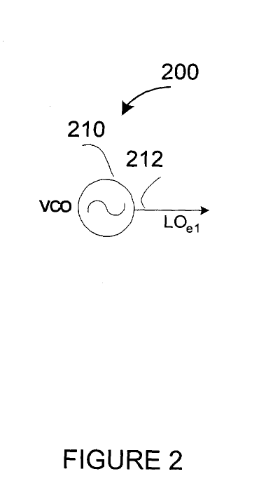

FIG. 2 depicts an implementation of VCO 200 wherein VCO 200 comprises a discrete component in a DCR. As previously described, VCO device 210 generates an output signal 212 of LOₑ₁.

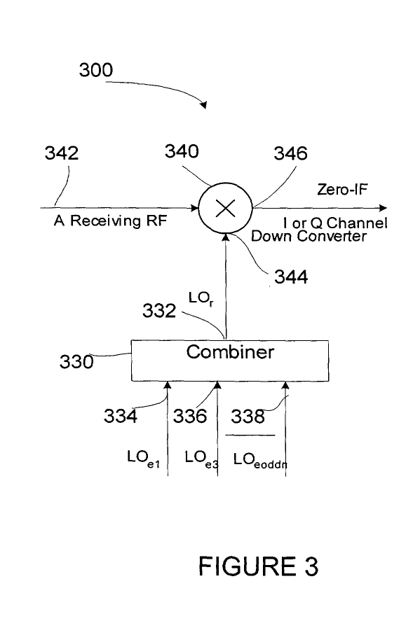

FIG. 3 depicts an implementation of a down converter device as a discrete component in a DCR. Down converter device 300 includes an APDP cell, a modified Gilbert cell, or similar circuit as known to those skilled in the art, circuit 340 and combiner (or adder) circuit 330. Combiner (or adder) circuit 330, having n inputs LOₑ₁, LOₑ₃ . . . LO_{eoddn} at ports 334, 336 and 338 combines the inputs to produce signal LOᵣ at output port 332. Output signal LOᵣ inputs to port 344 of down converter circuit 340. An APDP cell, modified Gilbert cell, or other like circuit as known to those skilled in the art, may be used as down converter circuit 340. Down converter circuit functions to mix a received RF signal at port 342 with the LOᵣ signal at port 344 to produce a zero-IF signal output at port 346. The zero-IF signal output can be for I-Channel or Q-Channel.

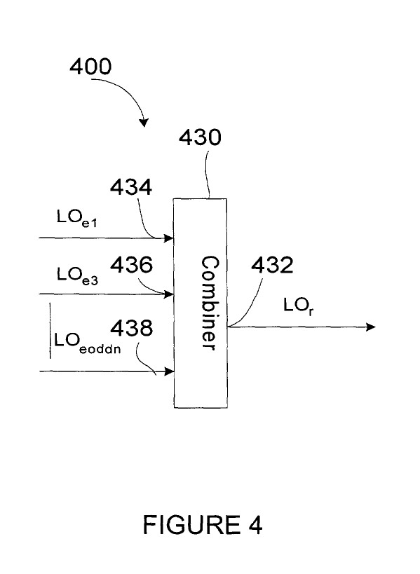

FIG. 4 illustrates an implementation where combiner device 400 is a discrete component in a DCR. Combiner (or adder) circuit 430 functions as previously described having n input ports 434, 436 . . . 438 with signals LOₑ₁, LOₑ₃, . . . LO_{eoddn} and produces output signal LOᵣ at port 432 which may be supplied to a down converter.

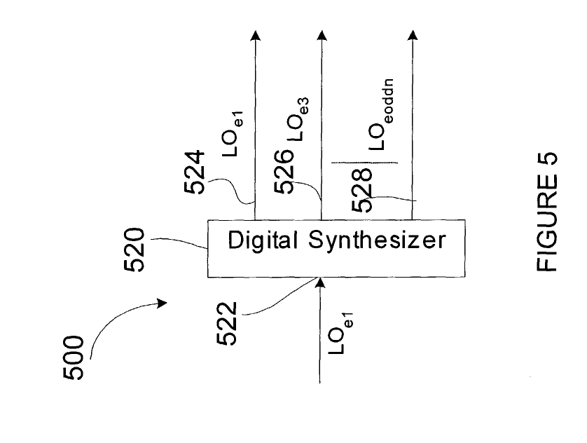

FIG. 5 illustrates an implementation of a digital synthesizer device 500 wherein these functions are implemented by a discrete component in a DCR. Digital synthesizer (or frequency multiplier) circuit 520 produces n lower frequencies (LOₑ₁, LOₑ₃, . . . LO_{eoddn}) at output ports 524, 526, 528, respectively, from input frequency LOₑ₁ on port 522.

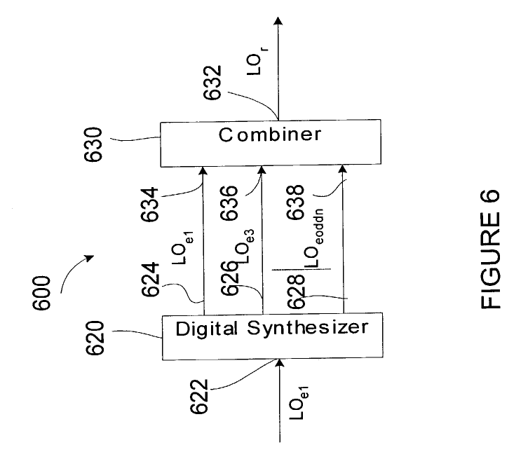

Alternatively, the above-discussed functions and circuits can be combined in various combinations as unique discrete devices. For example, FIG. 6 depicts a device wherein a digital synthesizer device 600 and combiner circuit 630 are integrated as a single component in a DCR. These circuits still function as previously described. Here digital synthesizer (or frequency multiplier) circuit 620 has n output ports 624, 626, 628 with signals LOₑ₁, LOₑ₃, . . . LO_{eoddn}. These outputs electrically connect to input ports 634, 636, 638 of combiner (or adder) circuit 630. The output port 632 of the combiner circuit 630 provides the LO frequency signal, LOᵣ, to a down converter.

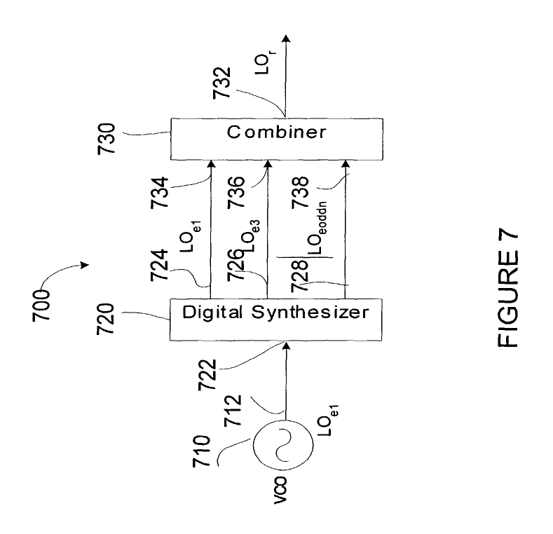

FIG. 7 illustrates another combination that includes digital synthesizer device 700, combiner circuit 730, and VCO circuit 710, integrated as a single component in a DCR. Digital synthesizer (or frequency multiplier) circuit 720 generates n number of output frequencies (LOₑ₁, LOₑ₃, . . . LO_{eoddn}) at output ports 724, 726, 728, respectively. These output ports electrically connect to input ports 734, 736, 738 of combiner (or adder) circuit 730. Output port 732 of combiner 730 provides signal LOᵣ to a down converter. VCO circuit 710 generates a signal of frequency LOₑ₁ at port 712 which serves as input port 722 of digital synthesizer (or frequency multiplier) circuit 720.

The present invention provides several benefits realized by using IHBT. First, a VCO frequency that is 2n times lower than the carrier frequency RF can be utilized. Second, lower frequencies can be used for the synthesizer design. Once a lower frequency LO and synthesizer are introduced to the down converter, all coupling and matching issues caused by the otherwise high frequencies disappear. Therefore, the implementation of DCR using SOC becomes easier when using the techniques of the present invention.

Simulations show the resulting circuit has a very high second order Input Intercept Point (IIP2) of about 50 dBm, a very high third order Input Intercept Point (ITP3) of about 18 dBm,. The simulations also show a 6 dB improvement in conversion loss and a 6 dB reduction in LO power.

The advantages of the present invention can be achieved using as few as two of the frequencies output from the digital synthesizer. In one embodiment, the combiner can combine just LOₑ₁ and LOₑ₃ to produce an LOᵣ that, when mixed with the received radio frequency signal in the down converter, produces a zero-IF signal output-having zero DC-offset.

Further advantages gained by using the techniques of the present invention include greatly reduced costs, since the need to use costly high frequency VCO and synthesizer circuits are eliminated. Power consumption also is reduced due to a lower LO power. These factors lead to the possibility of a SOC which integrates an analog baseband and down converter.

The present invention can be further described as a direct conversion receiver (DCR). This DCR includes a voltage controlled oscillator which generates an output signal at a frequency equal to the carrier frequency of the receiver divided by 2n, where n equals one of 1, 2, 3, 4, etc. This output inputs to a digital synthesizer or frequency multiplier circuit. The digital synthesizer (or frequency multiplier) circuit, outputs to n ports with an odd harmonic of the frequency output (LOₑ₁, LOₑ₃, . . . LO_{eoddn}) from the voltage controlled oscillator. LOₑ₁ is the input frequency; LOₑ₃ is the third harmonic of the input frequency; LO_{eoddn} is the n^{th} odd order harmonic of the input frequency. These output frequencies input into a combiner (or adder) circuit. The combiner (or adder) circuit, adds the input frequencies together to generate an output, connected to the input of a down converter. The down converter containing an APDP cell or a modified Gilbert cell mixes a received RF signal with the output of the combiner to produce a zero-IF signal output with zero DC-offset.

The present invention eliminates the need for a big DC-offset isolation capacitor in I-Channel and Q-Channel. Additionally, the present invention eliminates the need for a DC-offset cancellation algorithm inside a Modem attached to such a direct conversion receiver.

In another embodiment, the present invention can be further described as a direct conversion transmitter (DCT). This DCT includes a voltage controlled oscillator which generates an output signal at a frequency equal to the carrier frequency of the receiver divided by 2n, where n equals one of 1, 2, 3, 4, etc. This output inputs to a digital synthesizer or frequency multiplier circuit. The digital synthesizer (or frequency multiplier) circuit, outputs to n ports with an odd harmonic of the frequency output (LOₑ₁, LOₑ₃, . . . LO_{eoddn}) from the voltage controlled oscillator. LOₑ₁ is the input frequency; LOₑ₃ is the third harmonic of the input frequency; LO_{eoddn} is the n^{th} odd order harmonic of the input frequency. These output frequencies input into a combiner (or adder) circuit. The combiner (or adder) circuit, adds the input frequencies together to generate an output, connected to the input of an up converter. The up converter containing an APDP cell or a modified Gilbert cell mixes a transmitted RF signal with the output of the combiner to produce a zero-IF signal output with zero DC-offset.

Although the invention described here refers to particular embodiments, it is to be understood that these embodiments are merely illustrative of the principles and applications of the invention. It is therefore to be understood that numerous modifications may be made to the illustrative embodiments and that other arrangements may be devised without departing from the spirit and scope of the present invention as described in this disclosure.

What is claimed is:

1. A harmonic boosting technique that produces zero DC offsets and reduces LO frequency and power, comprising the steps of:
generating an output with a voltage controlled oscillator (VCO), wherein the VCO generates output LOₑ₁, and wherein the outputs are received by a digital synthesizer or frequency multiplier device;
producing a set of n odd harmonic frequencies, LOₑ₁, LOₑ₃ . . . LO_{eoddn} of LOₑ₁ with said digital synthesizer or frequency multiplier device as inputs for a combiner or adder circuit;
combining in said combiner or adder circuit these n odd frequencies together to become LOᵣ, an input to a down converter; and
mixing a received RF signal with the LOᵣ input to produce a zero intermediate frequency signal in said down converter.

2. The method of claim 1, wherein LOₑ₁ equals a carrier frequency RF divided by 2n, where n equals one of 1, 2, 3, 4, etc.

3. The method of claim 1, wherein said n odd harmonic frequencies comprise LOₑ₁, LOₑ₃ . . . LO_{eoddn} of LOₑ₁.

4. The method of claim 1, wherein said down converter comprises an APDP circuit or a modified Gilbert circuit.

5. The method of claim 1, wherein said zero-IF signal output is I-Channel or Q-Channel.

6. The method of claim 1, wherein the harmonic boosting technique can be applied with separate discrete devices in a direct conversion receiver system.

7. The method of claim 1, wherein the harmonic boosting technique can be applied with separate discrete devices in a direct conversion receiver using a system On a Chip.

8. The method of claim 7, wherein said a system On a Chip is manufactured using CMOS semiconductor technology.

9. The method of claim 8, wherein said separate discrete devices comprise said VCO that generates an output LOₑ₁ frequency which is a carrier frequency RF divided by 2n, where n equals one of 1, 2, 3, 4, etc.

10. The method of claim 8, wherein said separate discrete devices comprise said down converter, and wherein said down converter contains an APDP cell or a modified Gilbert cell circuit and a combiner (or adder) circuit.

11. The method of claim 8, wherein said separate discrete devices comprise said combiner or adder circuit.

12. The method of claim 8, wherein said separate discrete devices comprise an integrated digital synthesizer or frequency multiplier and a combiner.

13. The method of claim 8, wherein said separate discrete devices comprise an integrated VCO circuit, a digital synthesizer or frequency multiplier circuit and a combiner.

14. An apparatus to harmonically boost signals that produces zero DC offsets and reduces LO frequency and power, comprising the steps of:
a voltage controlled oscillator (VCO), wherein the VCO generates output LOₑ₁;
a digital synthesizer or frequency multiplier device that receives said output LOₑ₁ and produces a set of n odd harmonic frequencies, LOₑ₁, LOₑ₃ . . . LO_{eoddn} of LOₑ₁;
a combiner or adder circuit that mixes said n odd frequencies together to become LOᵣ;
a down converter which mixes a received RF signal with LOᵣ to produce a zero intermediate frequency signal.

15. A harmonic boosting technique that produces zero DC offsets and reduces LO frequency and power, comprising the steps of:
generating an output with a voltage controlled oscillator (VCO), wherein the VCO generates output LOₑ₁, and wherein the outputs are received by a digital synthesizer or frequency multiplier device;
producing a set of n odd harmonic frequencies, LOₑ₁, LOₑ₃ . . . LO_{eoddn} of LOₑ₁ with said digital synthesizer or frequency multiplier device as inputs for a combiner or adder circuit;
combining in said combiner or adder circuit these n odd frequencies together to become LOᵣ, an input to an up converter; and
mixing a transmitted RF signal with the LOᵣ input to produce a zero intermediate frequency signal in said up converter.

16. The method of claim 15, wherein the harmonic boosting technique can be applied with separate discrete devices in a direct conversion transmitter using a system On a Chip.

17. An apparatus to harmonically boost signals that produces zero DC offsets and reduces LO frequency and power, comprising the steps of:
a voltage controlled oscillator (VCO), wherein the VCO generates output LOₑ₁;
a digital synthesizer or frequency multiplier device that receives said output LOₑ₁ and produces a set of n odd harmonic frequencies, LOₑ₁, LOₑ₃ . . . LO_{eoddn} of LOₑ₁;
a combiner or adder circuit that mixes said n odd frequencies together to become LOᵣ;
a up converter which mixes a transmitted RF signal with LOᵣ to produce a zero intermediate frequency signal.

18. The apparatus of claim 17, wherein LOₑ₁ equals a carrier frequency RF divided by 2n, where n equals one of 1, 2, 3, 4, etc.

19. The apparatus of claim 17, wherein said n odd harmonic frequencies comprise LOₑ₁, LOₑ₃ . . . LO_{eoddn} of LOₑ₁.

20. The apparatus of claim 17, wherein said up converter comprises an APDP circuit or a modified Gilbert circuit.

21. The apparatus of claim 17, wherein said zero-IF signal output is I-Channel or Q-Channel.

22. The apparatus of claim 17, wherein the harmonic boosting technique can be applied with separate discrete devices in a direct conversion transmitter system.
